(19) United States
(12) Patent Application Publication
(10) Pub. No.: US 2023/0286852 A1
(43) Pub. Date: Sep. 14, 2023

(54) FILTER GLASS

(71) Applicant: Schott AG, Mainz (DE)

(72) Inventors: Bianca Schreder, Sulzbach (DE); Ute Wölfel, Mainz-Laubenheim (DE); Stefanie Hansen, Gensingen (DE); Ralf Biertümpfel, Mainz-Kastel (DE)

(73) Assignee: Schott AG, Mainz (DE)

(21) Appl. No.: 18/119,641

(22) Filed: Mar. 9, 2023

(30) Foreign Application Priority Data
Mar. 9, 2022 (DE) 10 2022 105 555.8

(51) Int. Cl. C03C 3/062; C03C 3/17; C03C 3/23; C03C 3/21; G02B 5/22

(52) U.S. Cl. CPC C03C 3/062; C03C 3/17; C03C 3/23; C03C 3/21; G02B 5/226

(57) ABSTRACT

A filter glass contains >1.1 to 6.0 wt % Li₂O and at least one further component selected from Na₂O and K₂O, and includes the following composition (in wt % based on oxide): 55.0-75.0 P₂O₅, 4.1-8.0 Al₂O₃, 8.0-18.0 CuO, 0-<0.8 V₂O₅, ≤2.0 SiO₂, ≤2.0 F, 0-11.0 Total R′O (R′=Mg, Ca, Sr, Ba, Zn), and 3.0-17.0 Total R₂O (R=Li, Na, K).

### CROSS REFERENCE TO RELATED APPLICATIONS

This application claims priority to German Patent Application No. DE 10 2022 105 555.8 filed on Mar. 9, 2022, which is incorporated in its entirety herein by reference.

### BACKGROUND OF THE INVENTION

### 1. Field of the Invention

The present invention relates to filter glasses, especially phosphate glasses, that have been colored blue for use as filters, and to the production thereof.

### 2. Description of the Related Art

The filter glasses of the abovementioned type may be used as what are called optical bandpass filters, i.e. as filters having a more or less narrow wavelength range of high transmittance (transmission range) bounded by two blocking ranges with very low transmittance. Such glasses find use as optical glass filters, for example as color correction filters in color video cameras, digital cameras and smartphone cameras. Further fields of use are filters for blocking of the near IR (NIR) radiation from LEDs, for example in displays, etc. As well as high transparency in the wavelength range between about 400 and about 600 nm, especially between 430 and 565 nm, a steep edge, i.e. a rapid drop in transmittance, toward the adjoining UV range from less than 400 nm and very low transmittance at wavelengths greater than 700 nm is desirable for such glasses. Likewise desirable is a very steep drop in the transmission curve toward the NIR region of the spectrum.

NIR-blocking filters are also used in the fields of aviation/navigation, and therefore a certain color locus fidelity is needed in the case of high blocking (e.g. white or green color locus). While the UV region is to be very substantially blocked, for example in order to prevent damage to sensitive electronic arrangements by the high-energy radiation, the intensity of the incident radiation in the region of greater than 700 nm is to be attenuated, so as to compensate, for example, when they are used in cameras, for the reddish tinge to the image caused by the CCD (charge coupled device) sensors.

For use as filters, copper oxide-containing fluorophosphate glasses are known from the prior art (e.g. DE 10 2012 210 552 A1, DE 10 2011 056 873 A1). However, these glasses have the disadvantage that the production thereof is difficult on account of the often very high fluorine contents, because fluorine itself and the fluorides of many glass components are volatile under the conditions of customary production processes. On account of the relatively high coefficient of thermal expansion thereof (measured in the temperature range between 20 and 300° C.) of >13×10⁻⁶/K, the processing, reprocessing and/or further processing (e.g. cutting, polishing, bonding in the course of wafer-level packaging) of the fluorophosphate glasses is very difficult and complex. For example, as a result of thermally induced mechanical stresses, the risk of fracture is high in the fixing of the glasses which is required for the purpose. Many attempts have therefore been made to optimize the compositions of fluorophosphate glasses with the aim of obtaining glasses which firstly have good stability and are secondly obtainable via economic production processes.

In addition, largely fluorine-free copper oxide-containing phosphate glasses are also known for use as filter glasses (e.g. US2007/0099787 A1, DE 40 31 469 C1, DE 102017207253 B3, CN 110255886 A, CN 110194592 A). Such glasses may have better processability on account of their lower coefficient of thermal expansion compared to fluorophosphate glasses. However, their weathering stability (also “climate stability”) is generally much worse than weathering stability of the fluorophosphate glasses. A further problem is that the raw materials for such glasses have high melting points and hence high melting temperatures, meaning that the raw materials of these glasses frequently melt only at temperatures well above 1100° C. (for example above 1200° C.). At such high temperatures, the equilibrium of the different oxidation states of copper (i.e. Cu(II):Cu(I):Cu(O)) already moves toward the lower oxidation states. This entails several disadvantages for filter applications, especially in the case of relatively high concentrations of copper oxide: firstly, transmittance at the UV edge is worsened as a result of higher proportions of monovalent copper (Cu(I); Cu₂O). Secondly, an increased amount of elemental copper (Cu(O)) is formed, which forms alloys with production elements of platinum, as a result of which these become thermally unstable, such that there is introduction of platinum into the glass, with the result that transmittance at the UV edge worsens further until the Pt components are destroyed. For stabilization of the higher oxidation state in the case of particular ions such as copper ions, in the case of known phosphate glasses, the addition of an oxidizing agent such as CeO₂, MnO₂, Cr₂O₃, V₂O₅ is considered necessary (e.g. US2007/0099787 A1; DE 40 31 469 C1).

In view of the decreasing size of components for electronic devices, there is an increasing need for very thin filters, i.e. ≤0.21 mm, for example with thicknesses of about 0.11 mm, for which the glasses have to be more intensely colored. A higher content of CuO can improve the steepness of the transmission curve toward the NIR region of the spectrum, but this in turn changes the equilibrium of the Cu(II):Cu(I) species, with the result that there is more Cu(I), as a result of which transmittance falls in the transmission region of the filter glass.

Moreover, a high content of CuO leads to problems in glass production, since the coloring components such as CuO, in the case of higher contents, not only act as coloring components but also, as glass constituents, affect the glass microstructure and other physical properties of the glass, in that Cu(I) and Cu(II) ions compete for available sites in the glass network with alkali metal ions and alkaline earth metal ions.

When copper-containing phosphate glasses are used for optical filters, although optical properties are very good, there have to date been limitations with regard to some aspects: firstly, phosphate glasses are only of limited weathering stability; secondly, mechanical strength is in some cases inadequate. Moreover, there are several trade-offs with regard to the composition: Al₂O₃ and SiO₂ can improve the climate resistance of the phosphate glasses on the one hand, but on the other hand contribute to an increase in melting temperatures coupled with the above-described adverse effects on the equilibrium of the copper species. The presence of alkali metal ions leads to a glass having a lower melting temperature, which is advantageous for the equilibrium of the copper species, but the alkali metal content in turn worsens the climate resistance of the glass.

Furthermore, the increasing miniaturization of the optical components entails ever lower filter thicknesses, but this requires much higher concentrations of CuO, in order to create the required optical properties. However, higher CuO contents lead to the problems set out above.

What is needed in the art is a way to provide filter glasses that solve the problems of the prior art.

### SUMMARY OF THE INVENTION

In some exemplary embodiments provided according to the present invention, a filter glass contains >1.1 to 6.0 wt % Li₂O and at least one further component selected from Na₂O and K₂O, and includes the following composition (in wt % based on oxide): 55.0-75.0 P₂O₅, 4.1-8.0 Al₂O₃, 8.0-18.0 CuO, 0-<0.8 V₂O₅, ≤2.0 SiO₂, ≤2.0 F, 0-11.0 Total R′O (R′=Mg, Ca, Sr, Ba, Zn), and 3.0-17.0 Total R₂O (R=Li, Na, K).

In some exemplary embodiments provided according to the present invention, a filter includes a filter glass. The filter glass contains >1.1 to 6.0 wt % Li₂O and at least one further component selected from Na₂O and K₂O, and includes the following composition (in wt % based on oxide): 55.0-75.0 P₂O₅, 4.1-8.0 Al₂O₃, 8.0-18.0 CuO, 0-<0.8 V₂O₅, ≤2.0 SiO₂, ≤2.0 F, 0-11.0 Total R′O (R′=Mg, Ca, Sr, Ba, Zn), and 3.0-17.0 Total R₂O (R=Li, Na, K).

In some exemplary embodiments provided according to the present invention, a process for producing a filter glass includes: adding at least one glass component as complex phosphate and/or metaphosphate; producing a melt of glass components without exceeding a melting temperature of 1250° C.; and adding nitrates and/or bubbling the glass melt with oxygen. The produced filter glass contains >1.1 to 6.0 wt % Li₂O and at least one further component selected from Na₂O and K₂O, and includes the following composition (in wt % based on oxide): 55.0-75.0 P₂O₅, 4.1-8.0 Al₂O₃, 8.0-18.0 CuO, 0-<0.8 V₂O₅, ≤2.0 SiO₂, ≤2.0 F, 0-11.0 Total R′O (R′=Mg, Ca, Sr, Ba, Zn), and 3.0-17.0 Total R₂O (R=Li, Na, K).

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a transmission curve for various filter glasses provided according to the present invention as well as for a filter glass known from the prior art;

FIG. 2 illustrates a transmission curve for an exemplary embodiment of a filter glass provided according to the present invention;

FIG. 3 illustrates a transmission curve for another exemplary embodiment of a filter glass provided according to the present invention;

FIG. 4 illustrates a transmission curve for another exemplary embodiment of a filter glass provided according to the present invention; and

FIG. 5 illustrates a transmission curve for another exemplary embodiment of a filter glass provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments provided according to the present invention provide a filter glass containing >1.1 to 6.0 wt % of Li₂O and at least one further component selected from Na₂O and K₂O and comprising the following composition (in wt % based on oxide):

| | |
|---|---|
| P₂O₅ | 55.0-75.0 |
| Al₂O₃ | 4.1-8.0 |
| CuO | 8.0-18.0 |
| V₂O₅ | 0-<0.8 |
| SiO₂ | ≤2.0 |
| F | ≤2.0 |
| Total R′O (R′ = Mg, Ca, Sr, Ba, Zn) | 0-11.0 |
| Total R₂O (R = Li, Na, K) | 3.0-17.0. |

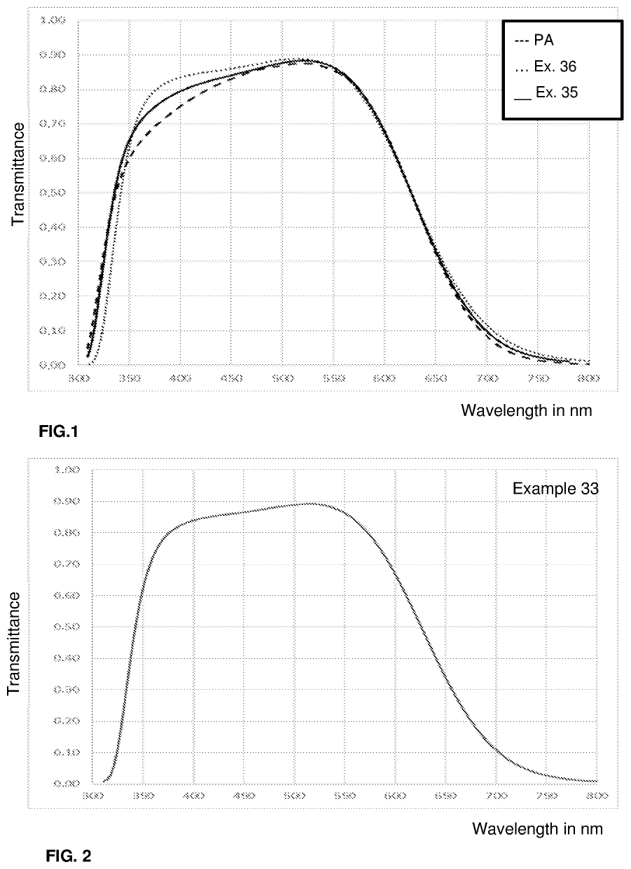

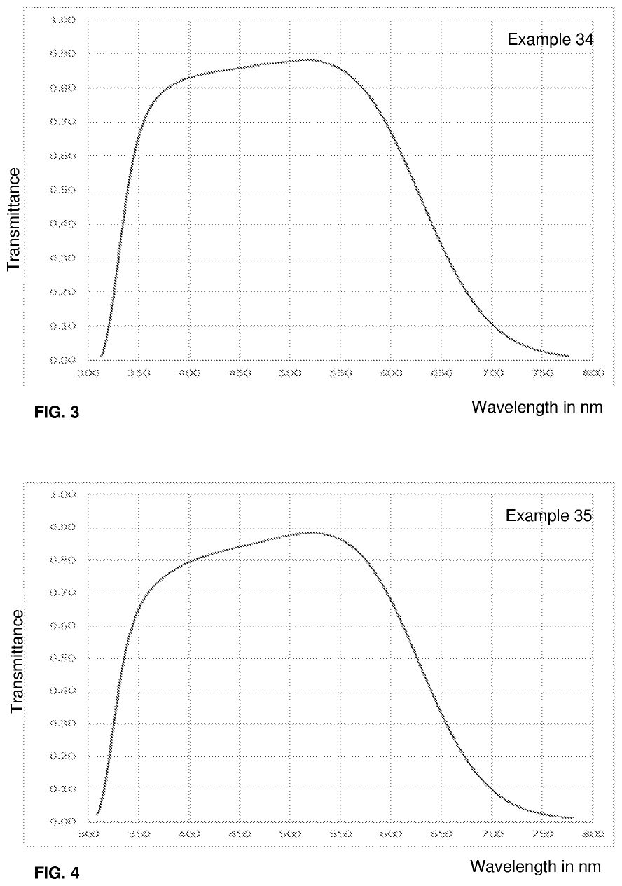

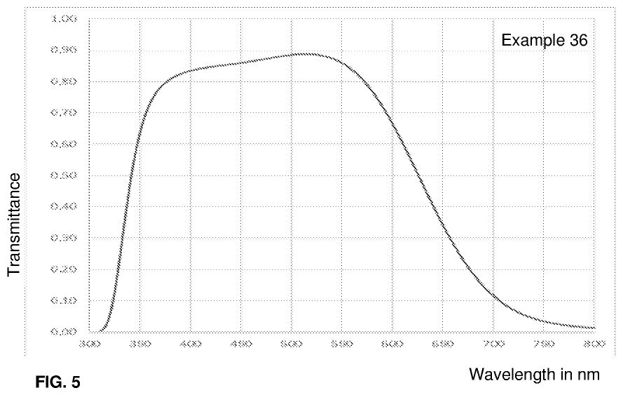

FIGS. 1 to 5 show transmission curves with advantageous transmittance properties of filter glasses having the inventive composition (Examples 33 to 36 from Table 3), based on a reference thickness of 0.205 mm. Filter glasses for the above-described applications, by contrast with other glasses, are often characterized by specific transmittance properties, for example average transmittance T_{avg} in a defined section of the transmission region and blocking in the barrier region. The reporting of a T₅₀ value may also be advantageous. These figures are given for a defined reference thickness which, in the context of the disclosure, is 0.205 mm, which does not mean that the glasses produced have this thickness.

The glasses provided according to the invention appear blue, blue-green, turquoise or cyan to the human eye, up to and including black in greater thicknesses and at high CuO contents, and may be used as IR cut filters. The colors here are secondary for many applications. Instead, it is the filter characteristics that result from absorption in the UV up to about 300 nm and in the near IR (NIR) at about 850 nm resulting from the addition of the coloring oxide CuO that are crucial for use as a filter, for example in front of the sensor of digital cameras. UV blocking is caused here by the base glass itself and by CuO. In order to maximize UV transmittance from a wavelength of 400 nm, especially from 430 nm—since shorter wavelengths are no longer perceived visually by the human eye, it is possible to use oxidizing agents such as nitrates and/or vanadium oxide (V₂O₅).

In some embodiments, the filter glass comprises, in wt %:

| | |
|---|---|
| P₂O₅ | 55.0-70.0 |
| Al₂O₃ | 4.1-7.0 |
| CuO | 8.0-18.0 |
| Li₂O | >1.1-6.0 |
| V₂O₅ | 0-<0.8 |
| SiO₂ | ≤2.0 |
| F | ≤2.0 |
| Total R′O (R′ = Mg, Ca, Sr, Ba, Zn) | 4-11.0 |
| Total R₂O (R = Li, Na, K) | 7.0-17.0 |
| Total P₂O₅ + Al₂O₃ | 63.0-<72.0. |

In some embodiments, the filter glass comprises, in wt %:

| | |
|---|---|
| P₂O₅ | 65.0-75.0 |
| Al₂O₃ | 5.0-8.0 |
| CuO | 8.0-18.0 |
| Li₂O | >1.1-6.0 |
| V₂O₅ | 0-<0.8 |
| SiO₂ | ≤2.0 |
| F | ≤2.0 |
| Total R′O (R′ = Mg, Ca, Sr, Ba, Zn) | 2.0-8.0 |
| Total R₂O (R = Li, Na, K) | 3.0-13.0 |
| Total P₂O₅ + Al₂O₃ | 72.0-81.0. |

In some embodiments, the filter glass comprises, in wt %:

| | |
|---|---|
| P₂O₅ | 65.0-75.0 |
| Al₂O₃ | 5.0-8.0 |
| CuO | 8.0-16.0 |
| Li₂O | 2-6.0 |
| V₂O₅ | 0-<0.8 |
| SiO₂ | ≤2.0 |
| F | ≤2.0 |
| Total (MgO + ZnO) | 1.0-8.0 |
| Total R₂O (R = Li, Na, K) | 3.0-13.0 |
| Total P₂O₅ + Al₂O₃ | 72.0-81.0. |

According to the invention, the glass contains phosphate (P₂O₅) with a proportion of 55.0 to 75.0 wt %. As a glass former, the content of phosphate in the glasses provided according to the invention is high at at least 55.0 wt %. The phosphate content should not be below this lower limit because the high CuO content for very thin NIR cut filters means that a high proportion of a network-forming component is required for stabilization against separation. Further exemplary lower limits may be at least 58.0 wt %, optionally at least 59.0 wt %, optionally at least 60.0 wt %, optionally at least 61.0 wt %, optionally at least 62.0 wt %. According to the invention, the upper limit for the phosphate content is at most 75.0 wt %. This upper limit should not be exceeded because glass stability against air humidity can otherwise deteriorate. In the case of higher P₂O₅ contents, the hygroscopic properties thereof become more apparent, which can lead to swelling and to cloudiness of the glass, and to the formation of voluminous salt layers on the surfaces. Exemplary embodiments of the glasses include at most 75.0 wt % or at most 74.0 wt % of P₂O₅, or at most 73.0 wt %. For embodiments with a high P₂O₅ content, at least 65.0 wt % or at least 66.0 wt % or at least 67.0 wt % or at least 68.0 wt % may be an advantageous lower limit for the phosphate content. For embodiments with a relatively low P₂O₅ content, at most 70.0 wt % or at most 69.0 wt % may be an advantageous upper limit.

Aluminium oxide (Al₂O₃) is used in order to increase the weathering stability of the glass, since it is one of the conditional network formers, but is not hygroscopic. Moreover, it improves the adhesion of a functional coating applied to the filter glass at a later stage, for example antireflection coating or another interference layer that can simultaneously protect the surface of the filter glass from moisture. Al₂O₃ is present in the glasses provided according to the invention in proportions of 4.1 to 8.0 wt %. The level should not go below the lower limit of 4.1 wt % in order to obtain adequate weathering stability. It is possible for at least 4.3 wt % or at least 4.5 wt % or at least 4.7 wt % of Al₂O₃ to be present in the glass. Some embodiments may also contain at least 5.0 wt % of Al₂O₃. The upper limit of 8.0 wt % should not be exceeded since higher Al₂O₃ contents increase the tendency of the glass to crystallize and especially the melting range of the glass. A glass having a higher melting range also has a higher melting temperature for the batch. The higher melting temperatures cause the melt to move into the reducing range. As a result, the equilibrium of those components in the melt that can occur in different oxidation states (for example Cu, V) moves toward the lower oxidation states. However, this undesirably alters the optical properties of the glass (for example absorption, transmittance) and hence the characteristic filter properties. In some embodiments the aluminium oxide content is at most 7.5 wt %, optionally at most 7.0 wt % or at most 6.7 wt % or at most 6.5 wt % or at most 6.3 wt %. For some embodiments, it is also possible for at most 6.0 wt % to be an upper limit for the Al₂O₃ content.

In order to assure sufficient stability in the glasses provided according to the invention, the proportion of glass formers, i.e. the sum total of phosphate and aluminium oxide (P₂O₅+Al₂O₃), may optionally together be at least 63.0 wt %. An exemplary upper limit for the sum total of phosphate and aluminium oxide may be at most 81.0 wt %. Within this wide range, it is possible to distinguish between exemplary embodiments: a embodiment with a relatively low sum total of P₂O₅+Al₂O₃ of 63.0 wt % to less than 72.0 wt % and a embodiment with a relatively high sum total of P₂O₅+Al₂O₃ of 72.0 wt % to 81.0 wt %.

For embodiments with a relatively low sum total of P₂O₅+Al₂O₃, at least 65.0 wt % or at least 67.0 wt % may be an advantageous lower limit and/or at most 71.5 wt % or at most 71.0 wt % may be an advantageous upper limit.

For embodiments with a relatively high sum total of P₂O₅+Al₂O₃, at least 73.0 wt % or at least 74.0 wt % may be an advantageous lower limit and/or at most 80.0 wt % or at most 79.0 wt % may be an advantageous upper limit.

It has also been found to be advantageous to adjust the weight or mass ratio of phosphate to aluminium oxide to a value of at least 8, optionally of at least 9, optionally of at least 10 and/or optionally at most 16. In some embodiments, this value is at most 15, such as at most 14.

Silicon oxide (SiO₂), like aluminium oxide, increases the tendency to crystallize and the temperature of the melting range of the glass, and worsens the optical properties of the glass by the shift in the equilibrium of the copper oxidation states. It should therefore be present in the glass—if at all—at not more than 2.0 wt %, optionally less than 2.0 wt %. In some embodiments, the glass provided according to the invention contains less than 1.5 wt %, optionally not more than 1.0 wt %, optionally less than 1.0 wt % SiO₂. A lower limit for SiO₂ may be at least 0.01 wt %. In some embodiments, the glass may be free of added SiO₂. Small proportions of less than 1.5 wt % may be present in SiO₂-containing melting tanks as a result of contaminations of the raw materials and/or as a result of the production process. However, SiO₂ may also be used deliberately in the glass within the scope of the limits indicated above, in order to improve adhesion of a functional coating applied to the filter glass at a later stage, as already described previously in connection with Al₂O₃. Good adhesion ensures that the coating applied is not detached from the glass surface over a long period.

As mentioned by way of introduction, the filter glass provided according to the invention belongs to the category of blue filters or IR cut filters. It therefore comprises, as coloring component, copper oxide (CuO) in amounts of 8.0 to 18.0 wt %. If copper oxide is used in excessively small amounts (i.e. the level is below the lower limit according to the invention of 8.0 wt %), the light-blocking or radiation-blocking effect in the NIR will be insufficient for the purposes of the invention because the absorption of Cu in the glass will then be too low at low glass thicknesses (for example 0.205 mm or 0.11 mm). It may be advantageous when the glass contains more than 8.0 wt % CuO, optionally at least 8.5 wt % or at least 9.0 wt %. Some embodiments may also contain at least 9.5 wt % or at least 10.0 wt % of CuO. The person skilled in the art will of course also be aware that the CuO content can also be lower depending on the objective; in other words, it is also possible to use contents of <8.0 wt % in association with the base glasses disclosed if different demands are being made on the filter glass, for example with regard to reference thickness, transmission, blocking and T₅₀.

In the context of the invention, the P₂O₅, Al₂O₃, R₂O components and optionally present components such as in particular R′O, SiO₂, B₂O₃, La₂O₃, Y₂O₃ form a base glass of the filter glass. The characteristic filter properties are adjusted via the addition of coloring components. The coloring components include CuO in particular, but also—if present—V₂O₅ and CeO₂, since these components affect the redox state of CuO and hence the absorption thereof. The base glass thus includes all components except for the coloring components and except for—if present—refining agents and component F, which serve to adjust color and to adjust quality or processing, while the composition of the base glass remains essentially the same.

If, meanwhile, an excessively high content of copper oxide is chosen, the transmittance of the glass will be adversely affected because either the absorption of Cu(I) in the UV will become too great or the glass will become opaque via Cu(O). Therefore, the upper limit of 18.0 wt % of CuO should not be exceeded. It may be advantageous when the glass contains not more than 17.0 wt %, optionally not more than 16.0 wt %, optionally not more than 15.0 wt % or not more than 14.0 wt % of CuO.

In order to maximize UV transmittance, the glass provided according to the invention may contain vanadium oxide (V₂O₅) with a proportion of 0 to <0.8 wt %. If vanadium oxide is present, at least 0.01 wt % or at least 0.03 wt % or at least 0.05 wt % may be an exemplary lower limit. The upper limit of less than 0.8 wt %, optionally of at most 0.7 wt % or at most 0.6 wt % or at most 0.5 wt % should not be exceeded since absorption in the visible region of the spectrum can occur at relatively high contents. V₂O₅-free embodiments are possible.

The glass provided according to the invention contains lithium oxide (Li₂O) with a proportion of more than 1.1 wt % to 6.0 wt %. In some embodiments, it is also possible for at least 1.2 wt % or, in relation to some embodiments, at least 1.5 wt % or at least 1.6 wt % Li₂O to be an exemplary lower limit. For some embodiments, it may be advantageous when at least 2.0 wt % of Li₂O is present.

Lithium ions have a similar ionic radius to Cu(I) ions, and so they compete with Cu(I) ions in the glass network. Higher contents of Li₂O (i.e. >1.1 wt % or optionally more) can thus achieve blocking of sites in the glass network for Cu(I) ions by lithium ions. This shifts the redox equilibrium of the Cu species in the direction of Cu(II), which causes an increase in transmittance at the UV edge and in average transmittance T_{avg} in the range of 430 to 565 nm.

It may be advantageous when an upper Li₂O limit of 6.0 wt %, such as of 5.5 wt % or 5.0 wt %, is not exceeded because the glass could otherwise be destabilized and climate resistance worsened.

The glass provided according to the invention, as well as Li₂O, contains at least one further component selected from potassium oxide (K₂O) and sodium oxide (Na₂O), i.e. at least two alkali metal oxides R₂O. Alkali metal oxides contribute to reducing the melting temperature of the glass. The aim of the use of the alkali metal oxides here is, in spite of a relatively high Al₂O₃ content for phosphate glasses, to obtain a batch that melts at minimum temperatures, in order to as far as possible suppress the formation of monovalent or elemental copper. In addition, alkali metal oxides facilitate the processing of the glass in that they act as a flux in the melt, i.e. reduce the viscosity of the glass. However, excessively large amounts of these oxides lower the glass transition temperature, impair the stability of the glasses, for example the climate resistance, and increase the coefficient of thermal expansion of the glass. If the latter is particularly high, the glass can no longer be subjected to optimal cold reprocessing. In addition, there is a drop in thermal stability, and it becomes more difficult to anneal the glass in the cooling lehr. High contents of alkali metal oxide increase the hygroscopic propensity of P₂O₅ in these glasses, as a result of which these glasses then not only have a tendency to significant salt exudation, but also incorporate a lot of water and actually swell up.

Therefore, the total content of alkali metal oxides (i.e. the sum total of R₂O (R=Li, Na, K)) should not go below a value of 3.0 wt %, for example optionally of 3.5 wt %, optionally of 4.0 wt %. For some embodiments, it is also possible for at least 5.0 wt % or at least 6.0 wt % or at least 7.0 wt % or at least 8.0 wt % to be an exemplary lower limit. In order not to endanger the stability of the glasses, the total content of these oxides should not exceed a value of 17.0 wt %, optionally 16.0 wt %, also optionally 15.0 wt %, and in some embodiments of the glass of 14.0 wt % or 13.0 wt %. For some embodiments with a relatively low R₂O content, it is also possible for at most 10.0 wt % or at most 9.0 wt % to be an exemplary upper limit.

Glasses provided according to the invention, for stabilization against devitrification, contain at least two representatives from the group of the alkali metal oxides: lithium oxide (Li₂O), potassium oxide (K₂O) and sodium oxide (Na₂O), i.e. Li₂O and at least one further component from R₂O. It has been found here to be advantageous when the content of the at least one further component from R₂O (i.e. Na₂O and/or K₂O) is at least 0.1 wt %, optionally at least or more than 0.3 wt % or at least 0.5 wt % or at least 0.7 wt % or at least 1.0 wt %.

Overall, it is advantageous to combine the alkali metal oxides lithium oxide, sodium oxide and potassium oxide because a combination exerts a stabilizing effect on the glass in the sense of a mixed alkali effect. Some embodiments of the filter glass therefore include Li₂O and Na₂O and K₂O.

However, other exemplary glasses may be those containing just two components from the R₂O group, i.e. Li₂O+Na₂O or Li₂O+K₂O.

The content of potassium oxide in the glass may be 0 to 11.0 wt %. K₂O may be used in order to finely adjust the steepness of the edge of the transmission curve toward the NIR region. Some glass embodiments use K₂O as a further R₂O component alongside Li₂O. An exemplary lower limit for K₂O may be at least 0.1 wt %, optionally at least 0.3 wt % or at least 0.5 wt % or at least 0.7 wt % or at least 1.0 wt %. With regard to the K₂O content, it is possible to distinguish between embodiments having a relatively high K₂O level and a relatively low K₂O level. In the case of the glasses having a relatively high K₂O level, it may be advantageous when the minimum amount of K₂O is not less than 3.0 wt %, because both the climate resistance and the steepness of the NIR edge are otherwise influenced unfavorably. The glass optionally contains at least 4.0 wt %, optionally at least 5.0 wt %, of K₂O. However, the content of potassium oxide should not exceed a value of at most 11.0 wt %, optionally at most 10.0 wt %, optionally at most 9.0 wt %. Otherwise, the chemical stability of the glass would be impaired too much. Embodiments with a relatively low K₂O content contain less than 3.0 wt %, optionally not more than 2.0 wt % or not more than 1.0 wt %, of K₂O. Some embodiments may also be free of K₂O, especially when they optionally have a relatively high Li₂O content. The NIR edge in this case may show a steep progression even without K₂O.

The content of sodium oxide in the glass may be 0 to 7.0 wt %. This component may be used in order to lower the melting range of the glass produced. This constituent can also improve devitrification stability. Some exemplary glass embodiments use Na₂O as a further R₂O component alongside Li₂O. An exemplary lower limit for Na₂O may be at least 0.1 wt %, optionally at least 0.3 wt % or at least 0.5 wt % or at least 0.7 wt % or at least 1.0 wt %. In some embodiments, the glass may contain at least 2 wt %, optionally at least 3 wt %, of Na₂O. On the basis of stability considerations, an amount of at most 7.0 wt %, optionally at most 6.0 wt %, optionally at most 5.0 wt %, should not be exceeded. Low-Na₂O glass embodiments may contain not more than 2 wt % or not more than 1 wt % of Na₂O. Some embodiments may also be free of Na₂O.

In the filter glasses provided according to the invention with a high CuO content, divalent cations—especially cations of alkaline earth metal oxides (such as MgO, CaO, BaO, SrO) and/or cations of ZnO—when the respective components are present in the glass, will compete with Cu(II) irons for sites in the glass network. In the context of the invention, the sum total of the alkaline earth metal oxides (i.e. MgO, CaO, BaO, SrO) and ZnO is referred to as R′O where R′=Mg, Ca, Ba, Sr, Zn. In order that more CuO can be present in the glass, therefore, the total of R′O in the filter glass provided according to the invention is limited to not more than 11.0 wt % or not more than 10.5 wt % or not more than 10.0 wt % or not more than 9.5 wt %. Some embodiments may also contain not more than 9.0 wt % or not more than 8.0 wt % or not more than 7.0 wt % of R′O. An excessively high proportion of R′O in phosphate glasses can have a destabilizing effect on the glass.

On the other hand, alkaline earth metal oxides—i.e. magnesium oxide (MgO), calcium oxide (CaO), barium oxide (BaO) and strontium oxide (SrO)—and zinc oxide (ZnO) can serve to adjust viscosity and improve the meltability of the glasses. Just like the alkali metal oxides, they are network modifiers. When R′O is present in an exemplary embodiment of a glass provided according to the invention, the content may be at least 0.1 wt %, optionally at least 0.5 wt %, optionally at least 1.0 wt %, optionally at least 2.0 wt %. R′O-free embodiments are possible.

In an exemplary embodiment, the limits mentioned for R′O relate to the sum total of MgO+ZnO. The sum total of MgO+ZnO may optionally be 1.0 to 8.0 wt %, optionally 2.0 to 7.0 wt %. Exemplary upper limits and lower limits for the MgO and ZnO components are described hereinafter.

The content of MgO in the filter glass may be 0 to 6.0 wt %.

Among the known alkaline earth metal oxides, some embodiments contain at least magnesium oxide (MgO). For such embodiments, an exemplary range for MgO may be 1.0 wt % to 5.0 wt %. Some embodiments may contain at least 1.0 wt %, optionally at least 2.0 wt %, optionally at least 3.0 wt %, of MgO. An exemplary upper limit for MgO for some embodiments may be not more than 5.0 wt %, optionally not more than 4.0 wt %. Optionally, in such embodiments, the content of R′O may be determined to a significant degree by MgO, meaning that CaO, BaO, SrO, ZnO are present—if at all—only in small proportions. It may be advantageous when, of the alkaline earth metal oxides, only MgO is present in the filter glass. Some exemplary embodiments, aside from MgO, do not include any further member from the group of R′O. The associated advantages are elucidated further herein.

In other embodiments, MgO is a comparatively minor component in relation to the total R′O content. Such embodiments contain less than 1.0 wt % of MgO, optionally not more than 0.7 wt % or not more than 0.5 wt % or not more than 0.3 wt %. MgO-free embodiments are also possible.

Calcium oxide (CaO) is an optional component in the context of the invention, meaning that CaO-free embodiments are possible. If CaO is present, this component is optionally not more than 3.0 wt %, optionally not more than 2.0 wt %, optionally not more than 1.0 wt % and/or optionally at least 0.01 wt %, optionally at least 0.1 wt %. CaO is less preferred as a glass component in the context of the invention, since calcium ions, owing to their size and charge, compete with copper ions for the sites in the glass network. In the case of glasses having very high CuO contents, an excessively high CaO content can thus contribute to faster attainment of the upper limit for the separation of the glass.

Barium oxide (BaO) and/or strontium oxide (SrO) may be present in some embodiments, for example each in a proportion of at least 0.01 wt % or at least 0.1 wt %. If BaO should be present, the upper limit is optionally not more than 11.0 wt %, optionally not more than 10.0 wt %, optionally not more than 9.0 wt % or not more than 8.0 wt %. BaO-rich embodiments may contain at least 5.0 wt % of BaO. Low-BaO embodiments may contain less than 5.0 wt % of BaO. The same limits are correspondingly applicable to SrO. The person skilled in the art is aware that a certain amount of BaO can be replaced by SrO. The effect of the BaO content in the glass in some embodiments may be that the absorption maximum of Cu(II) is shifted to higher wavelengths in the NIR region, such that more Cu(II) is needed to attain the same Tso. As a result, the NIR edge becomes steeper (owing to the logarithmic relationship of transmittance with absorption). In other words, the component is good on the one hand for edge steepness, but also promotes transformation of Cu(II) to Cu(I) with the described disadvantages for the UV edge and average transmittance in the transmission range.

Exemplary embodiments of the filter glasses provided according to the invention may be low in BaO and/or low in SrO, for example free of BaO and/or SrO. BaO and/or SrO are less preferred components in the case of such embodiments since they can result in lower stability to crystallization and poorer melting characteristics than alkali metal oxides or MgO or CaO in the glass. However, such embodiments nevertheless have a steep NIR edge.

Zinc oxide (ZnO) may be used in the filter glasses provided according to the invention with a content of 0 to 8 wt % and can serve, for example, to lower the coefficient of thermal expansion and increase heat resistance and improve annealability of the glass in the cooling lehr. There are some embodiments in which ZnO is used only in a small proportion of less than 1.0 wt %, optionally not more than 0.7 wt % or not more than 0.5 wt %. An exemplary lower limit may be at least 0.05 wt %. ZnO-free embodiments are possible.

Other exemplary embodiments contain at least 1.0 wt % of ZnO, optionally at least 2.0 wt % or at least 3.0 wt % and/or at most 8.0 wt % or at most 7.0 wt % or at most 6.5 wt % or at most 6.0 wt %. In such embodiments, the content of R′O may optionally be shaped essentially by ZnO, meaning that alkaline earth metal oxides are present—if at all—only in small proportions. Some embodiments, aside from ZnO, do not include any other member from the group of R′O.

In the context of the invention, it has been found that it is firstly important to restrict the total content of R′O at the upper end, as set out previously. Secondly, it has been recognized that the type and combination of the glass components selected from R′O influence the optical properties of the filter glass, especially the position and shape of the NIR edge of the transmission curve. R′O components, as network modifiers, determine the short-range order region of the glass, i.e. the internal structure. The coloring Cu(II) ions are positioned at the remaining sites, the absorption characteristics of which are influenced in each case by the “neighbors” surrounding the Cu(II) ion. The more inhomogeneous the glass network, the more different the individual absorption characteristics of the Cu(II) ions, and the broader the overall absorption band of the totality of Cu(II) species, the effect of which is that the NIR edge of the transmission curve has a less steep progression and blocking at 700 nm is worse. However, the simpler and more homogeneous the glass network, the fewer different sites with different surrounding situations exist for the Cu(II) ions, such that the individual absorption characteristics of the Cu(II) ions become more uniform, which leads to a steep NIR edge and low transmittance at 700 nm. The fewer different components from the R′O group are present in the glass, the greater the homogeneity of the glass network.

For the provision of an improved base glass with a homogeneous glass network, it may be advantageous when the filter glass contains not more than three components selected from the R′O group, i.e., for example, a combination of BaO+CaO+ZnO or a combination of BaO+CaO+MgO. Other exemplary filter glasses contain not more than two components selected from the group of R′O, i.e., for example, a combination of BaO+CaO or of BaO+MgO or of MgO+ZnO. Some embodiments of filter glasses contain just one component from the group of R′O, such as MgO or ZnO.

ZnO and/or MgO are used in the filter glass in some embodiments, since the ionic radii thereof are the same as those of the two Cu species and hence they create a fitting network structure in which CuO is sufficiently intercalated without crystallizing.

In some embodiments, a content of R₂O selected as described above ensures that the network sites that would be suitable for Cu(I) ions are occupied by alkali metal ions, which increases average transmittance in the range of 430 to 565 nm and improves the UV edge of the transmission curve.

In order to lower the coefficient of thermal expansion without destabilizing the filter glass, lanthanum oxide (La₂O₃) may be present in some embodiments of the glass provided according to the invention. La₂O₃ densifies the network and hence ensures an improvement in chemical resistance by lowering of the hygroscopic properties. If La₂O₃ is present, the content may be at least 0.01 wt %, optionally at least 0.1 wt %, optionally at least 0.5 wt %, optionally at least 1.0 wt %. Since La₂O₃ is a costly glass component, it may be advantageous when the proportion does not exceed an upper limit of at most 4.0 wt %, optionally at most 3.5 wt % or at most 3.0 wt %. Some embodiments may also be free of La₂O₃.

In order to lower the coefficient of thermal expansion without destabilizing the filter glass, yttrium oxide (Y₂O₃) may be present in some embodiments of the glass provided according to the invention. This component is helpful in lowering melting temperatures, since it dissolves very efficiently in the raw melt and hence increases the proportion thereof. If Y₂O₃ is present, the content may be at least 0.01 wt %, optionally at least 0.1 wt %, optionally at least 0.5 wt %, optionally at least 1.0 wt %. It may be advantageous when the proportion does not exceed an upper limit of at most 4.0 wt %, optionally at most 3.5 wt % or at most 3.0 wt %. Some embodiments may also be free of Y₂O₃.

The glass provided according to the invention may contain fluorine (F) in a proportion of not more than 2.0 wt %, optionally less than 2.0 wt %, optionally at most or less than 1.5 wt % or at most or less than 1.0 wt %. Some embodiments may contain not more than 0.8 wt %, optionally not more than 0.5 wt %, optionally not more than 0.4 wt % or not more than 0.3 wt % or not more than 0.2 wt %, of F. Some embodiments of the glass may be free of fluorine as added glass component. If fluorine should be present, 0.01 wt % may be a lower limit. The use of fluorides in the melt may be helpful in dewatering the melt, which leads to a denser glass network and hence to better glass stability because it is more difficult for mobile ions to penetrate into the glass network and be intercalated there. Fluorine does improve the weathering stability of the phosphate glasses. However, the production process for the glasses is difficult to control on account of the volatility of that component. Moreover, contents of fluorine make it more difficult to process the glasses mechanically, since such glasses have a higher coefficient of thermal expansion. Fluorine also moves the absorption band of Cu(II) further into the visible region (towards shorter wavelengths), as a result of which the T₅₀ is already attained with a relatively low CuO concentration. On account of the logarithmic relationship between absorption and transmittance, however, there is then a comparatively high T₇₀₀, i.e. relatively poor blocking at 700 nm. The person skilled in the art is of course aware that the fluorine content in the glass can also be increased depending on the objective, or may also be higher depending on the process regime, meaning that contents >2.0 wt % are also possible in connection with the base glasses disclosed if different demands are being made on the filter glass, for example with regard to reference thickness, transmittance, blocking and TSO.

Boron oxide (B₂O₃), like fluorine, has a tendency to evaporate, and so the content of boron oxide should only be very low. Moreover, boron also has an unfavorable effect on climate resistance. According to the invention, the boron oxide content should optionally be at most 1.0 wt %. It may be preferable when the boron oxide content is at most 0.7 wt % or at most 0.5 wt %. In some embodiments, no boron oxide as glass component is added to the glass provided according to the invention, meaning that the glass is free of B₂O₃. If B₂O₃ should be present, 0.01 wt % may be a lower limit.

In the context of the invention, it has been found that, surprisingly, the filter glasses can be produced with the desired transmission properties without addition of cerium oxide (CeO₂)—a component which is used in many known filter glasses of the type specified at the outset because it absorbs UV radiation, i.e. some embodiments are free of cerium oxide. The base glass, i.e. the phosphate glass without the coloring ions, has such good optical properties that CeO₂ is not needed. By virtue of this measure, the glass composition advantageously may have only two components in copper oxide and titanium oxide that can exist in different valencies according to the redox state of the melt, and therefore stable adjustment of the NIR edge is achievable in manufacture. The adjustment should be sufficiently exact as to enable compliance with the permitted T₅₀ tolerance for a finished filter. If, by contrast, CuO, V₂O₅ and CeO₂ are present in the glass, the stable adjustment of the NIR edge can be made considerably more difficult even in the case of continuous manufacture. If CeO₂ is present to a relatively minor degree in the filter glass, the content is less than 1.1 wt %, less than 0.65 wt %, less than 0.5 wt %. Some embodiments of filter glasses have an even lower content of CeO₂, i.e. less than 0.4 wt % or less than 0.3 wt % or less than 0.2 wt % or less than 0.1 wt % or less than 0.05 wt % or less than 0.01 wt %.

The glasses provided according to the invention are optionally free of iron oxide (Fe₂O₃) because this oxide can adversely affect the transmission properties of the glasses and can likewise contribute to the redox equilibrium of CuO, which makes it difficult to establish a stable process. If embodiments do contain iron oxide, the content thereof is limited to at most 0.25 wt %. Fe₂O₃ may get into the glass as an impurity via other components. In some embodiments, the glasses provided according to the invention do not comprise any further coloring oxides apart from copper oxide; in particular, it is free of cobalt oxide (CoO).

The glass provided according to the invention, as filter glass, is optionally free of other coloring components, such as Cr, Mn and/or Ni and/or optically active, such as laser-active, components such as Pr, Nd, Sm, Eu, Tb, Dy, Ho, Er and/or Tm. Moreover, the glass is optionally free of components harmful to health, such as oxides of As, Pb, Cd, Tl and Se. The glasses provided according to the invention are further optionally free of radioactive constituents.

The glass provided according to the invention is further optionally free of rare earth metal oxides such as niobium oxide (Nb₂O₅), ytterbium oxide (Yb₂O₃), gadolinium oxide (Gd₂O₃), and of tungsten oxide (WO₃) and/or of zirconium oxide (ZrO₂), with the exception, as described above, that La₂O₃ and Y₂O₃ may be present. Nb₂O₅ is sparingly soluble in the melt. Moreover, niobium is a polyvalent ion which is involved in the redox equilibrium in the melt. If it is in the lower oxidation state, it can result in browning of the glass. Gadolinium oxide, tungsten oxide, zirconium oxide and/or ytterbium oxide increase the risk of crystallization of the glass and can increase melting temperatures.

In some embodiments of the present invention, the glass provided according to the invention optionally consists of the aforementioned components to an extent of at least 90 wt %, optionally to an extent of at least 95 wt %, optionally to an extent of 99 wt %.

In some embodiments, the glass consists of the components P₂O₅, Al₂O₃, R′O, R₂O, CuO and V₂O₅ to an extent of 90 wt %, optionally 95 wt %, optionally to an extent of 97 wt %.

In some embodiments, the glass consists of the components P₂O₅, Al₂O₃, R′O, R₂O, CuO, V₂O₅, La₂O₃ and Y₂O₃ to an extent of 95 wt %, optionally to an extent of 98 wt %, optionally to an extent of 99 wt %.

In some embodiments of the present invention, the glass provided according to the invention is also optionally free of other components not mentioned in the claims or the description, meaning that, in such an embodiment, the glass consists essentially of the above-detailed components, with potential exclusion of individual components that are not mentioned or are mentioned. The expression “consist essentially of” here means that other components are present as impurities at most, but are not intentionally added to the glass composition as an individual component.

If the description says that the glasses are free of a component or do not contain a certain component, what this means is that this component may be present as an impurity at most in the glasses. This means that they are not added in significant amounts, if at all, as a glass component. According to the invention, insignificant amounts are amounts of less than 100 ppm, optionally less than 50 ppm and optionally less than 10 ppm.

Refining in the case of this glass is optionally effected primarily via physical refining, meaning that the glass is sufficiently mobile at the melting/refining temperatures that the bubbles can ascend. The addition of refining agents promotes the release or absorption of oxygen in the melt. Moreover, polyvalent oxides can intervene in the redox characteristics and hence promote the formation of Cu(II)O.

The glass provided according to the invention may include customary refining agents in small amounts. The sum total of the added refining agents is optionally at most 1.0 wt %, optionally at most 0.5 wt %. Refining agents present in the glass provided according to the invention may be at least one of the following components (in wt %):

| Sb₂O₃ | 0-1.0 and/or |
|---|---|
| As₂O₃ | 0-1.0 and/or |
| SnO | 0-1.0 and/or |
| Halide (Cl, F) | 0-1.0 and/or |
| SO₄²⁻ | 0-1.0 and/or |
| Inorganic peroxides | 0-1.0. |

Inorganic peroxides used may, for example, be zinc peroxide, lithium peroxide and/or alkaline earth metal peroxides.

In some embodiments of the present invention, the glass is As₂O₃-free, since this component is considered to be problematic for environmental reasons.

The coefficient of thermal expansion (α₂₀₋₃₀₀) measured for the temperature range of 20 to 300° C. of the filter glasses may be optionally at most 13×10⁻⁶/K, optionally at most 12.5×10⁻⁶/K and optionally at most 12×10⁻⁶/K. This avoids problems with thermally induced mechanical stress in further processing and joining technology. Mechanical strength is increased as a result. A lower limit for the coefficient of expansion may be at least 9.5×10⁻⁶/K, optionally at least 9.8×10⁻⁶/K, optionally at least 10×10⁻⁶/K.

The glasses provided according to the invention may have a maximum glass transition temperature or transformation temperature (T_{g}). The lower the T_{g}, the weaker the glass network and the more brittle the glass and hence the more prone it is to moisture. The higher the transformation temperature, the higher the hardness of the respective phosphate glass. Therefore, filter glasses provided according to the invention may advantageously have a transformation temperature of more than 350° C., optionally at least 375° C.

In addition, the glasses provided according to the invention have as low a melting range as possible (<T₃). Such glasses also have a correspondingly low melting temperature for the raw materials of the batch. In other words, according to the invention, the components of the glass are chosen so as to obtain a batch with a minimum melting temperature. The melting temperature of the batch may be less than 1250° C., optionally not more than 1200° C., and for some embodiments optionally not more than 1150° C. or not more than 1100° C. This low melting temperature may advantageously achieve the effect that the melt remains in the oxidizing range, and predominantly Cu(II)O is present. The formation of Cu(I) and metallic copper is thus suppressed. This gives a glass with high transmittance. In spite of the high copper content, these filter glasses are not cloudy and do not have a copper mirror on the surface. As a result, glasses provided according to the invention can be manufactured not just in special crucibles but also in melting tanks (i.e. continuous units).

Exemplary embodiments of filter glasses with a composition according to the invention feature good filter characteristics:

An exemplary embodiment of the filter glass, at a reference thickness of 0.205 mm, has average transmittance T_{avg} in the range from 430 to 565 nm of at least 83%, optionally at least 85%, optionally at least 86%. Some embodiments of the filter glasses even have a T_{avg} of at least 87%, based on a reference thickness of 0.205 mm. T_{avg} is a measure of the transmittance of the filter glass in the transmission region. In the context of the disclosure, the average transmittance is reported for the wavelength range of 430 to 565 nm. Average transmittance should be at a maximum within this range.

Transmittance at 700 nm (T₇₀₀), which is a measure of blocking in the NIR range, in some embodiments of the filter glass, is at most 12%, at most 11.5%, at most 11%, at most 10.5%, or at most 10%, based on a reference thickness of 0.205 mm. In conjunction with the T₅₀ (see below), the T₇₀₀ is a measure of the edge steepness of the transmission curve.

T₅₀ is the wavelength at which transmittance of a filter glass in the near IR region (NIR) is exactly 50%. Filter glasses with a composition according to the invention may have a steep NIR edge and permit stable adjustment of the NIR edge even in the case of continuous manufacture, such that it is possible to comply with the T₅₀ tolerance for the finished filter that is permitted for the respective field of use. Exemplary embodiments may have a T₅₀ in the range of 610 nm to 640 nm at a reference thickness of 0.205 mm. In some embodiments, T₅₀ may be in the range between 618 nm and 634 nm, optionally in the range between 620 and 632 nm, optionally in the range between 622 nm and 630 nm.

A transmission requirement on an exemplary filter glass may be that Tso, based on a reference thickness of 0.205 mm, is 626 nm±8 nm, optionally 626 nm±6 nm, optionally 626 nm±4 nm. In some embodiments, the abovementioned limits of T_{avg} and T₇₀₀ are applicable to these requirements on T₅₀. In some embodiments, the stated limits of T_{avg} and T₇₀₀ are applicable to a filter glass having a T₅₀ normalized to 626 nm. A change in the CuO content (increase or decrease) can adjust T₅₀ in a controlled manner.

In order to make transmission characteristics and blocking characteristics of the filter glasses comparable and to be able to assess the position and shape of the absorption edges, exemplary executions of the filter glasses are not just normalized with regard to the thickness of 0.205 mm, but the composition is also adjusted such that the filter glass has a T₅₀ of 626 nm.

In the context of this disclosure, what are thus disclosed are exemplary filter glasses which, at a reference thickness of 0.205 mm and a transmission curve normalized to a T₅₀ of 626 nm, have average transmittance T_{avg} in the range of 430-565 nm of at least 83% and transmittance at 700 nm of not more than 12% and hence exhibit a steep NIR edge. Further exemplary limits for T_{avg} and T₇₀₀ have been given above. Such optical properties are achieved when a CuO content according to the invention is established in the base glass (phosphate glass with a balanced content of Al₂O₃, components from the group of R₂O and R′O, and possibly further components that are described below). The person skilled in the art is aware of the way in which the CuO content in the glass has to be adjusted in the case of different demands on the filter glass—for example a different reference thickness or a different Tso, in order to achieve the respective specification.

The glass provided according to the invention has sufficiently good climate resistance or climate stability or weathering stability. On account of the compositions of the base glasses, adhesion to functional coatings is good, and these likewise contribute to the climate stability of the coated filters. In spite of possibly unprotected edges, the filter glass in the coated filter is sufficiently stable to moisture.

With glasses provided according to the invention, it has been possible to solve the problems described at the outset in filter glasses. It has been possible to largely or wholly dispense with fluorine, and nevertheless to provide a sufficiently weathering-stable phosphate glass with very high CuO contents. By virtue of the relatively low coefficient of thermal expansion (compared to fluorophosphate glasses), mechanical stability is improved and the risk of glass fracture on further processing is reduced. By virtue of the specific definition of the glass components and the specific selection of the raw materials via which the respective glass components get into the glass (for example in the form of complex phosphates), the melting temperature is kept low in the course of glass production. In this way, it is possible that high contents of CuO that are required for the production of thin filters are present in the glass and, nevertheless, the good filter characteristics (transmittance values, absorption values) are attained. By virtue of the specific selection of components from the group of R′O and R₂O, a base glass is provided in which the equilibrium of the Cu species is shifted from Cu(I) toward Cu(II) and in which the absorption characteristics of the Cu(II) ions are optimized such that the transmission curve of the filter glass has a steep NIR edge and low transmittance at 700 nm.

The invention also provides a filter. A filter provided according to the invention comprises an above-described filter glass provided according to the invention. It may be advantageous when the filter has at least one coating on at least one side, for example an organic layer, an interference layer system, a single protection layer or combinations thereof. It may optionally be an antireflection (AR) and/or UV/IR cut coating. These layers reduce reflections and increase transmission or enhance IR blocking or UV blocking. Such layers may especially be designed such that they specifically block wavelengths of less than 430 nm or greater than 565 nm. These layers are interference layers. In the case of an antireflection layer, this is applied on at least one side of the glass and is formed from 4 to 10 layers of different and/or alternating composition. In the case of a UV/IR cut coating, there are optionally even 50 to 70 layers of different and/or alternating composition that form the UV/IR cut coating. These layers optionally consist of hard metal oxides, such as, in particular, SiO₂, Ta₂O₃, TiO₂, Al₂O₃, or metal oxynitrides. These layers are optionally applied to different sides of the filter glass. Such coatings also further increase weathering stability/climate stability. Because the filter glass provided according to the invention enables better layer adhesion by virtue of its Al₂O₃ components, optionally in conjunction with SiO₂, the lifetime of the filter is increased.

Another important aspect of this invention is the process for production of the glasses provided according to the invention. If the steps described hereinafter are followed, the glasses claimed may be obtained.

For the production of the glasses provided according to the invention, the raw material added to the batch is optionally complex phosphate and/or metaphosphate. What is meant by the expression “complex phosphate” is that no phosphate in the form of “free” P₂O₅ is added to the batch, but in that glass components such as Na₂O, K₂O, etc. are added to the batch not in oxidic or carbonatic form, but rather as phosphate, for example Mg(H₂PO₄)₂, LiH₂PO₄, KPO₃, NaPO₃. This means that the phosphate is added as an anionic component of a salt, with the corresponding cationic component of this salt itself being a glass constituent. Metaphosphates (e.g. Al(PO₃)₃) are polyphosphates, especially with ring structures, which are used advantageously since they introduce more phosphate equivalents into the glass per cation equivalent. This has the advantage that the phosphate content (complex phosphates, metaphosphates) rises at the expense of free P₂O₅, which can lead to good controllability in melting characteristics and distinctly reduced evaporation and dusting effects, combined with improved internal quality. In addition, an increased proportion of free phosphate places elevated demands on the safety technology in the operation of production, which increases production costs. The measure according to the invention considerably improves the processability of the glass composition: the batch is drier and can be mixed better. Moreover, the weights are more correct than when raw materials that increasingly absorb water from the environment during storage are used. It may also be advantageous for fluorine-containing glass embodiments when fluorine is added in the form of a fluoride-containing raw material, especially with cations of calcium, magnesium, barium, strontium, alkali metals and/or aluminium.

Optionally only few glass components are added as oxides. The alkali metal oxides and alkaline earth metal oxides may also be introduced as carbonates.

According to the invention, the raw materials of the glass are chosen so as to result in as low-melting a batch as possible (melting temperature optionally less than 1250° C., optionally not more than 1200° C., and for some embodiments optionally not more than 1150° C. or not more than 1100° C.).

Adding nitrates to the batch can result in establishment of oxidizing conditions in the melt. Nitrates also act as fluxes and contribute to lowering of the melting temperatures. For absorption in the IR range, the presence of copper ions in the +2 valence state and—if present—of vanadium ions in the +5 valence state is important. The glass is therefore melted in a manner known per se under oxidizing conditions. Alternatively or additionally to the use of nitrates, it is also possible to implement oxygen bubbling in the melt (see below).

The glass provided according to the invention is melted from a uniform, previously well-mixed batch of appropriate composition in a batchwise melting unit, for example a Pt crucible, or a continuous melting unit, for example an (Al₂O₃—ZrO₂—SiO₂) tank, Pt tank or quartz glass tank, at temperatures of from 930 to 1250° C., then refined and homogenized. When the glass is melted, the components present in the crucible or tank material may be introduced into the glass. In other words, it is possible for up to 2.0 wt % of SiO₂ to be present in the glass after melting in a quartz glass tank, even if it is not added explicitly. Melting temperatures depend on the chosen composition.

In order to adjust the redox ratio in the melt, the glass can optionally be bubbled with oxygen. The glass provided according to the invention is especially producible by a method in which oxygen bubbling in the melt is conducted in a batchwise melt, for example a crucible melt, for a period of 10 to 40 minutes, optionally 10 to 30 minutes. In the case of a continuous melt, for example a melting tank, the bubbling can optionally be conducted continuously and optionally in the melting region of the tank. The flow rate of the oxygen is optionally a value of at least 40 litres per hour, optionally at least 50 l/h, and also optionally at most 80 l/h and optionally at most 70 l/h. The bubbling also serves to homogenize the melt. As well as its above-described effects, it also assists crosslinking in the glass.

If these parameters are taken into account, compliance with the composition ranges according to the invention will result in a glass provided according to the invention. The production process described here is part of this invention just as much as the glass producible therewith.

The refining of the glass is optionally conducted at 980 to not more than 1200° C. The temperatures should generally be kept low in order to keep evaporation of the volatile components such as Li₂O and P₂O₅ as low as possible.

The invention also provides the use of filter glasses provided according to the invention as filters, especially NIR cut filters. The invention additionally provides the use of these glasses for protection of CCDs in cameras. In addition, the filter glasses provided according to the invention may be used in the context of the invention in sectors such as security, aviation, night viewing and the like.

### Examples

For production of a filter glass having the composition according to a working example, a corresponding glass batch is mixed vigorously. This batch is melted at 1200° C. within a period of about 3 hours and bubbled with oxygen for about 30 minutes. Owing to the low viscosity, refining is likewise effected at 1100-1150° C. After being left to stand for about 15 to 30 minutes, casting is effected at a temperature of about 950° C.

The glasses have a Knoop hardness HK of about 400 to 450—some embodiments may also have even higher values up to about 475—and hence have good processability and simultaneously adequate scratch resistance. The coefficients of thermal expansion are 9.5×10⁻⁶/K to <13×10⁻⁶/K, measured for the temperature range of 20 to 300° C. The glass transition temperatures T_{g} of the glasses are in the range of 350 to 450° C.

Spectral properties were assessed using a spectrophotometer (Perkin-Elmer Lambda 900 and 950). Polished glass samples with thicknesses of 0.205 mm up to and including 0.6 mm were produced, transmittance was measured, if necessary transmittance was calculated for the reference thickness of 0.205 mm, and the figure was reported for that reference thickness in Tables 1 to 5.

Table 1 shows the results for the working examples (Examples 1 to 15) and a comparative example (Example 16), based on the reference thickness of 0.205 mm. The working examples show an average transmittance (T_{avg}) in the range from 430 to 565 nm of more than 83%. Transmittance at 700 nm (T₇₀₀), which is a measure of blocking in the NIR region, in many examples, is not more than 12%. The working examples shown show high transmittance in the transmission range and blocking in the NIR range, but still have not been optimized with regard to a particular T₅₀.

Table 2 shows filter glasses of optimized composition with regard to a steep progression of the NIR edge of the transmission curve, based on the reference thickness of 0.205 mm. The compositions are adjusted such that the filter glasses meet the specification requirement “T₅₀ of 626 nm”. Examples 17 to 31 are working examples; example 32 is a comparative example. The working examples show an average transmittance (T_{avg}) in the range from 430 to 565 nm of more than 83%. Apart from Example 30, a Tₐvg of at least 86% is actually obtained. Transmittance at 700 nm (T₇₀₀) in all working examples is not more than 12%, and in many working examples is less than 11%.

Table 3 shows further working examples (Examples 33 to 40) of filter glasses having optimized composition with regard to a steep progression of the NIR edge of the transmission curve, based on the reference thickness of 0.205 mm. The working examples show average transmittance (T_{avg}) in the range from 430 to 565 nm of more than 86%. Transmittance at 700 nm (T₇₀₀) in all working examples is less than 12%. Further physical properties were determined on these glasses.

Table 5 shows further working examples (Examples 43 to 53) of filter glasses with optimized composition with regard to a steep progression of the NIR edge of the transmission curve, based on the reference thickness of 0.205 mm. The working examples show average transmittance (T_{avg}) in the range from 430 to 565 nm of more than 83%. Transmittance at 700 nm (T₇₀₀) in all working examples is less than 12%. Further physical properties were determined on some of these glasses.

The working examples of Tables 2, 3 and 5 thus show filter glasses with high transmittance in the transmission range, high blocking in the NIR range at a T₅₀ of 626 nm and hence with a steep progression of the NIR edge, which is apparent in FIGS. 1 to 5. By way of comparison, FIG. 1 shows a transmission curve of a filter glass from the prior art. The known filter glass, with a reference thickness of 0.205 mm and a T₅₀ of 626 nm, has much lower transmittance in the transmission range and also a lower Tₐvg in the range from 430 to 565 nm than the filter glasses provided according to the invention that have been disclosed.

Table 4 shows the results for the working examples (Examples 41 to 42), based on a reference thickness of 0.205 mm. The working examples show average transmittance (T_{avg}) in the range from 430 to 565 nm of more than 83%. Transmittance at 700 nm (T₇₀₀), which is a measure of blocking in the NIR range, in many examples is not more than 15%. The working examples shown show high transmittance in the transmission region and blocking in the NIR region, but have not yet been optimized with regard to a particular T₅₀.

The person skilled in the art is familiar with the way in which the copper content in the base glass can be adjusted if different demands are made on the filter glass in relation to target thickness and/or T₅₀.

TABLE 1
Examples in wt %

| | Example No. | | | | | | | |
|---|---|---|---|---|---|---|---|---|
| | 1 | 2 | 3 | 4 | 5 | 6 | 7 | 8 |
| P₂O₅ | 63.9 | 62.2 | 58.6 | 65.0 | 63.1 | 62.8 | 59.3 | 66.1 |
| Al₂O₃ | 4.4 | 5.7 | 5.2 | 4.3 | 4.8 | 4.8 | 4.1 | 4.8 |
| B₂O₃ | | | | | 0.6 | | 0.4 | |
| SiO₂ | | | | | | | | |
| ZnO | 0.4 | | | 0.5 | 0.5 | 0.5 | | 0.4 |
| MgO | | | 0.2 | | | | 0.2 | |
| CaO | 0.7 | | 0.6 | 0.7 | 0.7 | 0.7 | 0.6 | 0.7 |
| BaO | 6.7 | 9.2 | 6.7 | 5.5 | 5.6 | 5.7 | 6.8 | 6.3 |
| SrO | | | | | | | | |
| Li₂O | 4.7 | 2.9 | 1.9 | 4.3 | 4.5 | 4.7 | 1.9 | 3.0 |
| Na₂O | 1.9 | | 4.1 | 4.5 | 4.3 | 4.3 | 4.2 | |
| K₂O | 5.6 | 8.9 | 9.5 | 3.2 | 3.2 | 3.3 | 9.5 | 5.1 |
| CuO | 11.4 | 10.8 | 11.4 | 11.7 | 11.4 | 11.7 | 11.6 | 10.9 |
| F | | | 1.8 | | 1.3 | 1.5 | 1.4 | |
| Y₂O₃ | | | | | | | | 1.7 |
| V₂O₅ | 0.3 | 0.3 | | 0.3 | | | | 0.3 |
| La₂O₃ | | | | | | | | 0.7 |
| Total | 100.0 | 100.0 | 100.0 | 100.0 | 100.0 | 100.0 | 100.0 | 100.0 |
| T_{avg} | 87.1% | 86.9% | 85.2% | 87.0% | 86.0% | 85.2% | 85.8% | 87.1% |
| (430-565 nm) | | | | | | | | |
| T_{700 nm} | 5.0% | 6.0% | 5.0% | 6.0% | 6.0% | 6.0% | 5.0% | 9.2% |
| T₅₀ (nm) | 612 | 613 | 611 | 614 | 615 | 616 | 613 | 623 |
| | Example No. | | | | | | | |
| | | | | | | | | 16 |
| | 9 | 10 | 11 | 12 | 13 | 14 | 15 | (comp.) |
| P₂O₅ | 66.5 | 63.7 | 66.0 | 73.0 | 65.5 | 67.8 | 68.1 | 59.4 |
| Al₂O₃ | 4.8 | 5.5 | 4.8 | 6.9 | 4.3 | 5.3 | 5.0 | 5.0 |
| B₂O₃ | | | | | | | | |
| SiO₂ | | | | 0.1 | 1.0 | 0.1 | | |
| ZnO | 0.4 | | 0.4 | | 0.4 | 0.4 | 0.4 | |
| MgO | | | | | | | | |
| CaO | 0.7 | 0.7 | 0.7 | | 0.7 | 0.7 | 0.7 | 0.6 |
| BaO | 6.4 | 7.9 | 6.3 | 4.4 | 6.3 | 6.3 | 6.1 | 11.9 |
| SrO | | | | | | | 0.5 | |
| Li₂O | 3.1 | 1.6 | 2.0 | 2.5 | 2.0 | 2.1 | 2.2 | 1.9 |
| Na₂O | | | 2.1 | | 2.1 | 2.0 | 2.2 | 3.9 |
| K₂O | 5.1 | 9.8 | 4.1 | 1.6 | 4.1 | 4.1 | 4.2 | 8.6 |
| CuO | 11.0 | 8.5 | 10.9 | 11.2 | 10.9 | 10.9 | 10.3 | 7.5 |
| F | | 0.9 | | | | | | 0.9 |
| Y₂O₃ | 1.7 | 1.1 | 1.8 | | 1.8 | | | |
| V₂O₅ | 0.3 | 0.3 | 0.2 | 0.3 | 0.2 | 0.3 | 0.3 | 0.3 |
| La₂O₃ | | | 0.7 | | 0.7 | | | |
| Total | 100.0 | 100.0 | 100.0 | 100.0 | 100.0 | 100.0 | 100.0 | 100.0 |
| T_{avg} | 87.3% | 88.5% | 87.9% | 86.9% | 88.2% | 84.2% | 88.4% | 82.7% |
| (430-565 nm) | | | | | | | | |
| T_{700 nm} | 9.7% | 17.4% | 10.6% | 14.3% | 11.5% | 12.9% | 15.6% | 14.0% |
| T₅₀ (nm) | 624 | 638 | 627 | 634 | 629 | 631 | 638 | 632 |

TABLE 2
Examples in wt % with T₅₀ of 626 nm

| | Example No. | | | | | | | |
|---|---|---|---|---|---|---|---|---|
| | 17 | 18 | 19 | 20 | 21 | 22 | 23 | 24 |
| P₂O₅ | 65.4 | 63.8 | 60.3 | 66.4 | 64.7 | 64.6 | 61.0 | 66.6 |
| Al₂O₃ | 4.5 | 5.8 | 5.4 | 4.4 | 4.9 | 4.9 | 4.2 | 4.8 |
| B₂O₃ | | | | | 0.6 | | 0.4 | |
| SiO₂ | | | | | | | | |
| ZnO | 0.4 | | | 0.5 | 0.5 | 0.5 | | 0.4 |
| MgO | | | 0.2 | | | | 0.2 | |
| CaO | 0.7 | | 0.7 | 0.7 | 0.7 | 0.7 | 0.7 | 0.7 |
| BaO | 6.9 | 9.4 | 6.9 | 5.7 | 5.7 | 5.8 | 7.0 | 6.3 |
| SrO | | | | | | | | |
| Li₂O | 4.8 | 3.0 | 1.9 | 4.4 | 4.7 | 4.8 | 2.0 | 3.1 |
| Na₂O | 2.0 | | 4.3 | 4.6 | 4.4 | 4.5 | 4.3 | |
| K₂O | 5.7 | 9.1 | 9.8 | 3.3 | 3.2 | 3.3 | 9.8 | 5.1 |
| CuO | 9.3 | 8.6 | 8.6 | 9.7 | 9.3 | 9.4 | 9.0 | 10.3 |
| F | | | 1.9 | | 1.3 | 1.5 | 1.4 | |
| Y₂O₃ | | | | | | | | 1.7 |
| V₂O₅ | 0.3 | 0.3 | | 0.3 | | | | 0.3 |
| La₂O₃ | | | | | | | | 0.7 |
| Total | 100.0 | 100.0 | 100.0 | 100.0 | 100.0 | 100.0 | 100.0 | 100.0 |
| T_{avg} | 88.3% | 88.0% | 87.0% | 88.0% | 87.3% | 86.6% | 87.2% | 87.4% |
| (430-565 nm) | | | | | | | | |
| T_{700 nm} | 11.6% | 12.0% | 11.5% | 11.1% | 11.0% | 10.8% | 10.9% | 10.7% |
| T₅₀ (nm) | 626 | 626 | 626 | 626 | 626 | 626 | 626 | 626 |
| | Example No. | | | | | | | |
| | | | | | | | | 32 |
| | 25 | 26 | 27 | 28 | 29 | 30 | 31 | (comp.) |
| P₂O₅ | 66.8 | 62.5 | 65.8 | 71.7 | 65.1 | 66.7 | 66.1 | 58.4 |
| Al₂O₃ | 4.8 | 5.4 | 4.7 | 6.7 | 4.2 | 5.2 | 4.9 | 4.9 |
| B₂O₃ | | | | | | | | |
| SiO₂ | | | | 0.1 | 1.0 | 0.1 | | |
| ZnO | 0.4 | | 0.4 | | 0.4 | 0.4 | 0.4 | |
| MgO | | | | | | | | |
| CaO | 0.7 | 0.7 | 0.7 | | 0.7 | 0.7 | 0.7 | 0.6 |
| BaO | 6.4 | 7.7 | 6.3 | 4.3 | 6.2 | 6.2 | 6.0 | 11.7 |
| SrO | | | | | | | 0.4 | |
| Li₂O | 3.1 | 1.6 | 2.0 | 2.4 | 2.0 | 2.0 | 2.2 | 1.9 |
| Na₂O | | | 2.1 | | 2.0 | 2.0 | 2.1 | 3.8 |
| K₂O | 5.2 | 9.6 | 4.1 | 1.5 | 4.0 | 4.1 | 4.1 | 8.5 |
| CuO | 10.6 | 10.3 | 11.2 | 13.0 | 11.7 | 12.3 | 12.8 | 9.0 |
| F | | 0.9 | | | | | | 0.9 |
| Y₂O₃ | 1.7 | 1.0 | 1.8 | | 1.8 | | | |
| V₂O₅ | 0.3 | 0.3 | 0.2 | 0.3 | 0.2 | 0.3 | 0.3 | 0.3 |
| La₂O₃ | | | 0.7 | | 0.7 | | | |
| Total | 100.0 | 100.0 | 100.0 | 100.0 | 100.0 | 100.0 | 100.0 | 100.0 |
| T_{avg} | 87.5% | 87.6% | 87.8% | 86.0% | 87.9% | 83.3% | 87.5% | 81.6% |
| (430-565 nm) | | | | | | | | |
| T_{700 nm} | 10.6% | 10.3% | 10.1% | 9.8% | 9.8% | 10.0% | 8.9% | 11.1% |
| T₅₀ (nm) | 626 | 626 | 626 | 626 | 626 | 626 | 626 | 626 |

TABLE 3
Examples in wt % with T₅₀ of 626 nm and further properties

| | Example No. | | | | | | | |
|---|---|---|---|---|---|---|---|---|
| | 33 | 34 | 35 | 36 | 37 | 38 | 39 | 40 |
| P₂O₅ | 62.1 | 66.7 | 71.6 | 66.3 | 71.7 | 70.7 | 71.3 | 71.7 |
| Al₂O₃ | 5.3 | 4.8 | 5.8 | 6.2 | 5.6 | 5.7 | 5.7 | 5.6 |
| B₂O₃ | | | | | | | | |
| SiO₂ | 0.2 | | 0.4 | 0.2 | | 0.8 | 0.7 | 0.7 |
| ZnO | | 0.4 | 5.3 | | 5.2 | 5.7 | 5.4 | 5.3 |
| MgO | | | | 3.5 | | | | |
| CaO | 0.7 | 0.7 | | | | | | |
| BaO | 7.6 | 6.4 | | | | | | |
| SrO | | | | | | | | |
| Li₂O | 1.6 | 3.1 | 3.7 | 1.2 | 3.6 | 3.1 | 3.6 | 3.5 |
| Na₂O | | | 0.7 | 5.0 | 0.6 | 0.6 | 0.7 | 0.6 |
| K₂O | 9.5 | 5.1 | | 6.2 | | 1.1 | | |
| CuO | 10.8 | 10.8 | 12.3 | 9.0 | 13.3 | 12.0 | 12.4 | 12.4 |
| F | 0.9 | | 0.1 | 0.8 | | 0.2 | 0.2 | 0.2 |
| Y₂O₃ | 1.0 | 1.7 | | | | | | |
| V₂O₅ | 0.3 | 0.3 | 0.1 | 0.1 | | 0.1 | 0.1 | 0.02 |
| La₂O₃ | | | | 1.5 | | | | |
| Total | 100.0 | 100.0 | 100.0 | 100.0 | 100.0 | 100.0 | 100.0 | 100.0 |
| T_{avg} | 87.8% | 87.2% | 86.1% | 87.1% | 83.9% | 86.6% | 87.2% | 88.4% |
| (430-565 nm) | | | | | | | | |
| T_{700 nm} | 11.0% | 11.0% | 10.0% | 11.7% | 10.0% | 10.0% | 10% | 9.5% |
| T₅₀ (nm) | 626 | 626 | 626 | 626 | 626 | 626 | 626 | 626 |
| CTE_{(20; 300)} | | 11.3 | | 11.9 | 9.9 | | 9.98 | 10.08 |
| (ppm/K) | | | | | | | | |
| Tg (° C.) | | 375 | | 404 | 384 | | 386 | 384 |
| Modulus of | 58 | 66 | | 69 | 71 | | | |
| elasticity | | | | | | | | |
| (GPa) | | | | | | | | |

TABLE 4
Examples in wt %

| Example No. | 41 | 42 |
|---|---|---|
| P₂O₅ | 70.5 | 73.0 |
| Al₂O₃ | 5.7 | 5.7 |
| B₂O₃ | | |
| SiO₂ | 0.8 | 0.7 |
| ZnO | 5.7 | 5.3 |
| MgO | | |
| CaO | | |
| BaO | | |
| SrO | | |
| Li₂O | 3.6 | 3.6 |
| Na₂O | 0.6 | 0.7 |
| K₂O | | |
| CuO | 12.8 | 10.8 |
| F | 0.2 | 0.2 |
| Y₂O₃ | | |
| V₂O₅ | 0.13 | 0.02 |
| La₂O₃ | | |
| Total | 100.0 | 100.0 |
| T_{avg} | 87.0% | 89.0% |
| (430-565 nm) | | |
| T_{700 nm} | 10% | 15% |
| T₅₀ (nm) | 623 | 636 |
| CTE _{(20; 300)} | 9.93 | 10.08 |
| (ppm/K) | | |
| Tg (° C.) | 395 | 384 |

TABLE 5
Examples in wt % with T₅₀ of 626 nm

| | Example No. | | | | | | | |
|---|---|---|---|---|---|---|---|---|
| | 43 | 44 | 45 | 46 | 47 | 48 | 49 | 50 |
| P₂O₅ | 70.5 | 73.0 | 71.7 | 71.7 | 71.3 | 70.2 | 70.1 | 68.2 |
| Al₂O₃ | 5.7 | 5.6 | 5.7 | 5.6 | 5.8 | 5.7 | 6.2 | 6.6 |
| B₂O₃ | | | | | | | | |
| SiO₂ | 0.8 | 0.8 | 0.7 | 0.7 | 0.3 | 0.3 | 0.3 | 0.3 |
| ZnO | 5.7 | 5.2 | 5.3 | 5.3 | 5.4 | 5.3 | 5.2 | 5.2 |
| MgO | | | | | | | | |
| CaO | | | | | | | | |
| BaO | | | | | | | | |
| SrO | | | | | | | | |
| Li₂O | 3.6 | 3.7 | 3.7 | 3.5 | 3.1 | 1.7 | 1.5 | 1.9 |
| Na₂O | 0.6 | 0.6 | 0.7 | 0.7 | 0.7 | 0.7 | 0.6 | 0.6 |
| K₂O | | | | | 1.2 | 3.9 | 4.1 | 4.3 |
| CuO | 11.8 | 11.8 | 12.1 | 12.3 | 12.0 | 11.9 | 11.8 | 12.5 |
| F | 0.2 | 0.3 | 0.2 | 0.2 | 0.2 | 0.3 | 0.2 | 0.4 |
| Y₂O₃ | | | | | | | | |
| V₂O₅ | 0.13 | 0.09 | 0.09 | 0.02 | 0.10 | 0.10 | 0.10 | 0.11 |
| La₂O₃ | | | | | | | | |
| Total | 100.0 | 100.0 | 100.0 | 100.0 | 100.0 | 100.0 | 100.0 | 100.0 |
| T_{avg} | 87.1% | 87.6% | 87.4% | 87.5% | 86.6% | 87.0% | 83.3% | 86.4% |
| (430-565 nm) | | | | | | | | |
| T_{700 nm} | 10.0% | 10.1% | 10.1% | 10.4% | 10.0% | 9.8% | 11.0% | 11.0% |
| T₅₀ (nm) | 626 | 626 | 626 | 626 | 626 | 626 | 626 | 626 |
| CTE_{(20; 300)} | 9.93 | 10.12 | 9.98 | | | | | |
| (ppm/K) | | | | | | | | |
| Tg (° C.) | 395 | 385 | 388 | | | | | |

| | Example No. | | |
|---|---|---|---|
| | 51 | 52 | 53 |
| P₂O₅ | 69.8 | 69.2 | 67.3 |
| Al₂O₃ | 6.3 | 6.6 | 6.8 |
| B₂O₃ | | | |
| SiO₂ | 0.3 | 0.3 | 0.3 |
| ZnO | 4.9 | 4.7 | 4.5 |
| MgO | | | |
| CaO | | | |
| BaO | | | |
| SrO | | | |
| Li₂O | 1.8 | 1.8 | 2.3 |
| Na₂O | 0.1 | | |
| K₂O | 4.6 | 5.2 | 6.2 |
| CuO | 11.8 | 11.8 | 12.0 |
| F | 0.3 | 0.3 | 0.4 |
| Y₂O₃ | | | |
| V₂O₅ | 0.11 | 0.08 | 0.08 |
| La₂O₃ | | | |
| Total | 100.0 | 100.0 | 100.0 |
| T_{avg} (430-565 nm) | 86.4% | 86.4% | 85.7% |
| T_{700 nm} | | | |
| T₅₀ (nm) | 10.5% | 10.5% | 11.4% |
| CTE_{(20; 300)} (ppm/K) | 626 | 626 | 626 |
| Tg (° C.) | | | |

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A filter glass, comprising:
>1.1 to 6.0 wt % of Li₂O and at least one further component selected from Na₂O and K₂O, and comprising the following composition (in wt % based on oxide):

| | |
|---|---|
| P₂O₅ | 55.0-75.0; |
| Al₂O₃ | 4.1-8.0; |
| CuO | 8.0-18.0; |
| V₂O₅ | 0-<0.8; |
| SiO₂ | ≤2.0; |
| F | ≤2.0; |
| Total R′O (R′ = Mg, Ca, Sr, Ba, Zn) | 0-11.0; and |
| Total R₂O (R = Li, Na, K) | 3.0-17.0. |

2. The filter glass of claim 1, wherein at least one of the following is satisfied:
the filter glass contains the at least one further component selected from Na₂O and K₂O with a content of at least 0.3 wt %; or
the filter glass contains Li₂O and Na₂O and K₂O.

3. The filter glass of claim 1, wherein at least one of the following is satisfied:
total R′O is at most 10.5 wt %;
the filter glass contains a maximum of two component selected from the group of R′O; or
the filter glass contains only one component selected from the group of R′O.

4. The filter glass of claim 1, wherein the content of CuO is not more than 17.0 wt % and/or at least 8.5 wt %, and/or V₂O₅ is present at not more than 0.6 wt %.

5. The filter glass of claim 1, wherein the filter glass contains La₂O₃ with a content of not more than 4.0 wt % and/or Y₂O₃ with a content of not more than 4.0 wt %.

6. The filter glass of claim 1, wherein the glass is free of at least one of:
B₂O₃, ZrO₂, Nb₂O₅, Yb₂O₃, Gd₂O₃, WO₃, Fe₂O₃, PbO and/or CoO;
other coloring components; or
optically active components.

7. The filter glass of claim 6, wherein the glass is free of other coloring components, the other coloring components comprising Cr, Mn, and/or Ni.

8. The filter glass of claim 6, wherein the glass is free of optically active components comprising Pr, Nd, Sm, Eu, Tb, Dy, Ho, Er and/or Tm.

9. The filter glass of claim 8, wherein the glass is free of laser-active components.

10. The filter glass of claim 1, wherein at least one of the following is satisfied:
the filter glass, based on a reference thickness of 0.205 mm, has an average transmittance T_{avg} in a range of 430-565 nm of at least 83%; or
the filter glass, based on a reference thickness of 0.205 mm, has a transmittance at 700 nm of not more than 12%.

11. The filter glass of claim 10, wherein at least one of the following is satisfied:
the filter glass, based on a reference thickness of 0.205 mm, has an average transmittance T_{avg} in the range of 430-565 nm of at least 86%; or
the filter glass, based on a reference thickness of 0.205 mm, has a transmittance at 700 nm of not more than 11%.

12. The filter glass of claim 1, wherein a T₅₀ of the glass at a reference thickness of 0.205 mm is in a range between 610 nm and 640 nm.

13. The filter glass of claim 12, wherein the T₅₀ is in the range between 620 nm and 632 nm.

14. The filter glass of claim 1, wherein at least one of the following is satisfied:
a coefficient of thermal expansion (α₂₀₋₃₀₀) of the glass is not more than 13×10⁻⁶/K;
a coefficient of thermal expansion (α₂₀₋₃₀₀) of the glass is at least 9.5×10⁻⁶/K; or
a transformation temperature of the glass is more than 350° C.

15. The filter glass of claim 14, wherein the coefficient of thermal expansion (α₂₀₋₃₀₀) of the glass is not more than 12.5×10⁻⁶/K and/or at least 9.8×10⁻⁶/K.

16. A filter, comprising:
a filter glass comprising >1.1 to 6.0 wt % of Li₂O and at least one further component selected from Na₂O and K₂O, and comprising the following composition (in wt % based on oxide):

| | |
|---|---|
| P₂O₅ | 55.0-75.0; |
| Al₂O₃ | 4.1-8.0; |
| CuO | 8.0-18.0; |
| V₂O₅ | 0-<0.8; |
| SiO₂ | ≤2.0; |
| F | ≤2.0; |
| Total R′O (R′ = Mg, Ca, Sr, Ba, Zn) | 0-11.0; and |
| Total R₂O (R = Li, Na, K) | 3.0-17.0. |

17. The filter of claim 16, wherein the filter glass has at least one coating on at least one of its surfaces.

18. A process for producing a filter glass, comprising:
adding at least one glass component as complex phosphate and/or metaphosphate; producing a melt of glass components without exceeding a melting temperature of 1250° C.; and
adding nitrates and/or bubbling the glass melt with oxygen, wherein the produced filter glass comprises >1.1 to 6.0 wt % of Li₂O and at least one further component selected from Na₂O and K₂O, and comprising the following composition (in wt % based on oxide):

| | |
|---|---|
| P₂O₅ | 55.0-75.0; |
| Al₂O₃ | 4.1-8.0; |
| CuO | 8.0-18.0; |
| V₂O₅ | 0-<0.8; |
| SiO₂ | ≤2.0; |
| F | ≤2.0; |
| Total R′O (R′ = Mg, Ca, Sr, Ba, Zn) | 0-11.0; and |
| Total R₂O (R = Li, Na, K) | 3.0-17.0. |
